(19) United States
(12) Patent Application Publication
(10) Pub. No.: US 2019/0041622 A1
(43) Pub. Date: Feb. 7, 2019

(54) LIGHT SHEET ILLUMINATION MICROSCOPE

(71) Applicant: OLYMPUS CORPORATION, Tokyo (JP)

(72) Inventor: Go RYU, Tokyo (JP)

(73) Assignee: OLYMPUS CORPORATION, Tokyo (JP)

(21) Appl. No.: 16/038,668

(22) Filed: Jul. 18, 2018

(30) Foreign Application Priority Data
Aug. 2, 2017 (JP) 2017-149581

(51) Int. Cl. G02B 21/16; G02B 21/36; H04N 5/225

(52) U.S. Cl. CPC G02B 21/16; G02B 21/361; G01N 21/6458; H04N 5/2254; G02B 21/365; H04N 5/2256

(57) ABSTRACT

A light sheet illumination microscope includes: an illumination optical system that irradiates a medium with sheet-shaped excitation light; a detection optical system that has an optical axis that intersects an optical axis of the illumination optical system, and detects fluorescence emitted by the medium that is irradiated with the light; a focus adjustment mechanism that changes a focus position of the detection optical system in a direction of the optical axis; and a controller. The controller controls, according to at least a first refractive index and a second refractive index, the focus adjustment mechanism when a wavelength of the fluorescence detected by the detection optical system is switched from a first wavelength to a second wavelength, the first refractive index being a refractive index of the medium with respect to the first wavelength, the second refractive index being a refractive index of the medium with respect to the second wavelength.

### CROSS REFERENCE TO RELATED APPLICATIONS

This application is based upon and claims the benefit of priority from prior Japanese Patent Application No. 2017-149581, filed Aug. 2, 2017, the entire contents of which are incorporated herein by this reference.

### BACKGROUND OF THE INVENTION

### Field of the Invention

The present invention relates to a light sheet illumination microscope.

### Description of the Related Art

In general, when a light sheet illumination microscope is used, the focus position of a detection optical system that detects fluorescence may be shifted with respect to a plane irradiated with sheet light when the position of a plane, in a sample, that is irradiated with excitation light is changed due to the position of the sample being changed in a direction of an optical axis of the detection optical system. The reason is that a plurality of media (for example, a sample, a culture solution, and air) of different refractive indexes are situated between the detection optical system and the plane irradiated with excitation light, and due to the position of the sample being changed, the thickness of each medium through which fluorescence passes changes in an optical path between the irradiated plane and the detection optical system.

Japanese Laid-open Patent Publication No. 2016-151701 discloses a technology that corrects the focus position of a detection optical system using an amount of a change in the thickness of a medium between the detection optical system and a plane irradiated with excitation light.

### SUMMARY OF THE INVENTION

A light sheet illumination microscope according to an aspect of the present invention includes: an illumination optical system that irradiates a medium with sheet-shaped excitation light; a detection optical system that has an optical axis that intersects an optical axis of the illumination optical system, and detects fluorescence emitted by the medium that is irradiated with the excitation light; a focus adjustment mechanism that changes a focus position of the detection optical system in a direction of the optical axis of the detection optical system; and a controller that controls, according to at least a first refractive index and a second refractive index, the focus adjustment mechanism when a wavelength of the fluorescence detected by the detection optical system is switched from a first wavelength to a second wavelength, the first refractive index being a refractive index of the medium with respect to the first wavelength, the second refractive index being a refractive index of the medium with respect to the second wavelength.

### BRIEF DESCRIPTION OF THE DRAWINGS

The present invention will be more apparent from the following detailed description when the accompanying drawings are referenced.

FIG. 1 illustrates a configuration of a light sheet illumination microscope according to an embodiment of the present invention;

FIG. 2 illustrates a hardware configuration of a controller;

FIG. 3 illustrates a functional configuration of the controller;

FIG. 4 illustrates two states in a first example that are a state in which excitation light of a first wavelength (λ1) is irradiated, and a state in which the focus position has been offset according to an offset amount after the wavelength of the excitation light is switched from the first wavelength to a second wavelength (λ2);

FIG. 5 illustrates two states in a second example that are a state before the position is changed and a state after the position is changed by a drive motor 7 (a position adjustment mechanism);

FIG. 6 illustrates two states in the second example that are the state before the position is changed and a state in which a shift amount after the position is changed by the drive motor 7 (the position adjustment mechanism) has been offset; and

FIG. 7 is a flowchart that illustrates an example of a procedure performed using the light sheet illumination microscope 100 when an offset calculator 22 performs processing in the second example.

### DESCRIPTION OF THE EMBODIMENTS

When pieces of fluorescence of different wavelengths are observed by switching the wavelength of excitation light, there is a problem in which the focus position is changed due to a refractive index of a medium with respect to light being changed every time the wavelength of excitation light is changed.

Thus, a technology is desired that makes it possible to correct not only a shift of the focus position with respect to a plane irradiated with sheet light due to the position of a sample being changed but also a shift of the focus position with respect to a plane irradiated with sheet light due to the wavelength of excitation light being switched.

A light sheet illumination microscope 100 according to an embodiment of the present invention is described below.

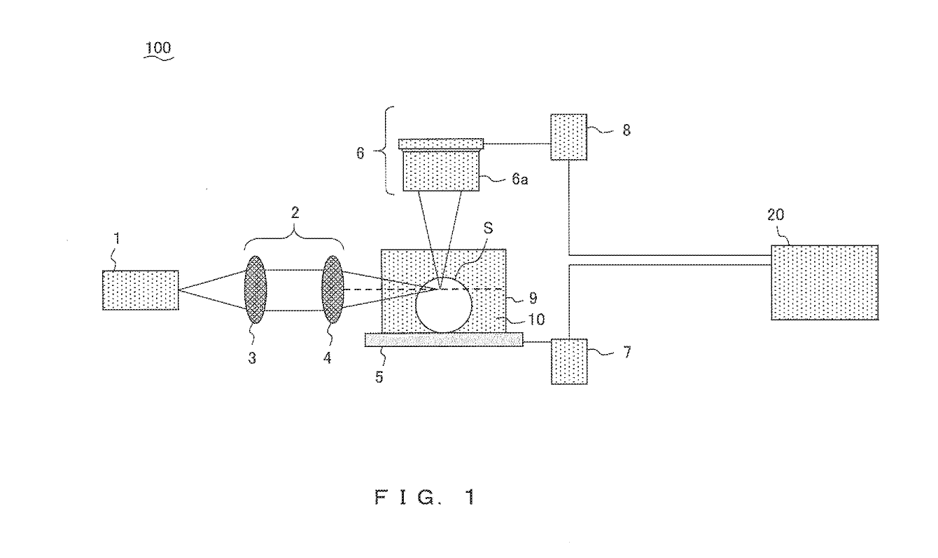

FIG. 1 illustrates a configuration of the light sheet illumination microscope 100.

The light sheet illumination microscope 100 includes a light source 1, an illumination optical system 2, a stage 5, a detection optical system 6, drive motors 7 and 8, and a controller 20. A sample S is accommodated in a container 9 along with a culture solution 10, and the container 9 is fixed on the stage 5. Further, the sample S and the culture solution 10 have refractive indexes equal to each other, and are also hereinafter referred to as media.

The light source 1 outputs excitation light. Further, the light source 1 can output pieces of excitation light of a plurality of wavelengths and a wavelength of the light to be output is switched by being controlled by the controller 20.

The illumination optical system 2 includes an optical system that guides excitation light from the light source 1 to a medium (the sample S, the culture solution) situated on the stage 5. The illumination optical system 2 includes, for example, a lens 3 and a cylindrical lens 4.

The cylindrical lens 4 has a power only in a Z direction, and irradiates the sample S with sheet-shaped excitation light (sheet light) that has an expansion in a plane. When the direction of an illumination optical axis is an X direction, a Y direction that is a direction in which the sheet light has an expansion is also referred to as a direction of the width of the sheet light.

The detection optical system 6 has an optical axis in the Z direction that intersects the optical axis of the illumination optical system 2, and detects fluorescence emitted by the sample (medium) situated on the stage 5 and irradiated with excitation light. It is desirable that the detection optical system 6 has an optical axis in the direction orthogonal to the optical axis of the illumination optical system 2. The detection optical system 6 includes an optical system that includes an objective 6a, and a photodetector. The wavelength detected by the detection optical system 6 is set to include a wavelength of generated fluorescence.

The drive motor 7 is a position adjustment mechanism that drives the stage 5 in the Z direction so as to change a relative distance between the detection optical system 6 and the stage 5. It is sufficient if the position adjustment mechanism is configured to change the relative distance between the detection optical system. 6 and the stage 5, and the position adjustment mechanism may be configured to drive the detection optical system 6 so as to change the relative distance between the detection optical system 6 and the stage 5. The stage 5 may include a rack and pinion, ball nut or the like. The detection optical system may include a rack and pinion, ball nut or the like.

The drive motor 8 is a focus adjustment mechanism that drives the detection optical system 6 in the Z direction so as to move a focus position of the detection optical system 6 in the Z direction (the direction of the optical axis of the detection optical system 6).

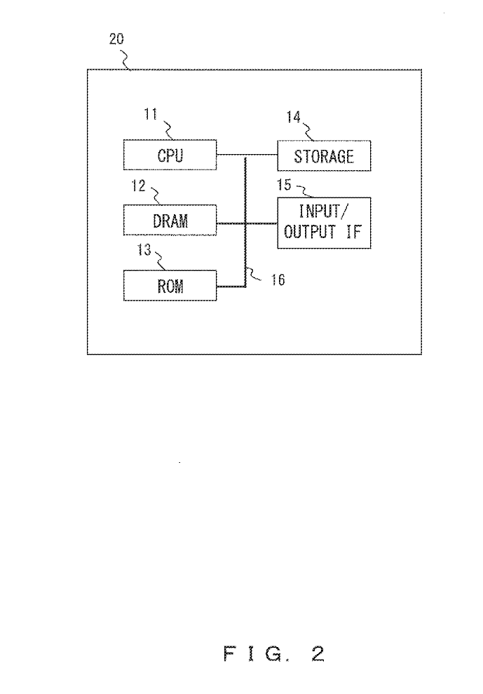

The controller 20 is a computer that controls various components of the light sheet illumination microscope 100. FIG. 2 illustrates a hardware configuration of the controller 20.

The controller 20 includes a CPU 11, a DRAM 12, a ROM 13, a storage 14, and an input/output IF 15.

The CPU 11 reads various control programs (such as a program of an offset calculator 22 described later) stored in the ROM 13 so as to execute the programs.

The DRAM 12 provides a working area that is used to temporarily store a control program and various data. The ROM 13 is a storage medium that nonvolatilely stores therein the various control programs.

The storage 14 stores therein various data and includes, for example, a flash memory or a hard disk. The input/output IF 15 transmits/receives data to/from the outside of the controller (such as an input device or a monitor). The components described above are connected to one another via a bus 16.

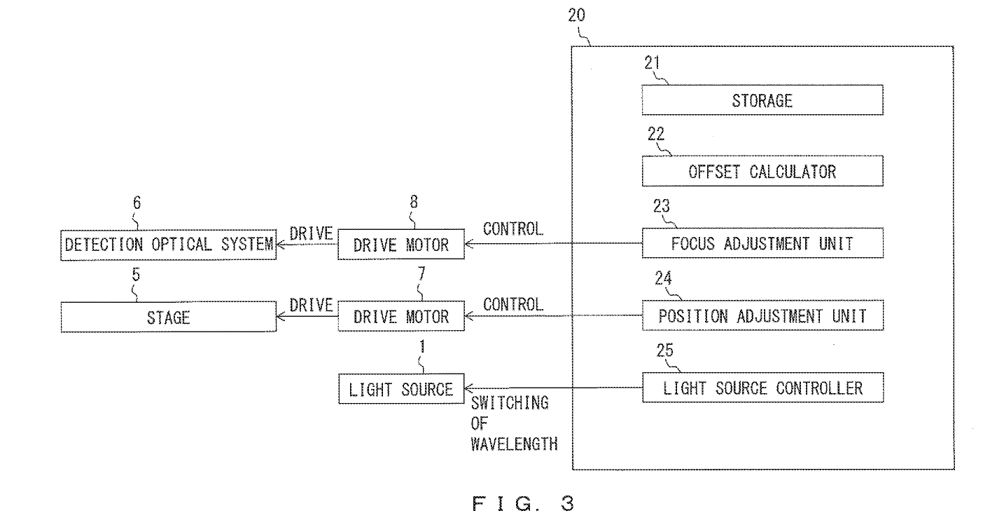

FIG. 3 illustrates a functional configuration of the controller 20.

A storage 21 corresponds to, for example, the storage 14 of FIG. 2 and has stored therein data that is needed, for example, when a control is performed by the offset calculator 22 described later. As the data described above, the storage 21 has stored therein, for each wavelength of generated fluorescence, a refractive index of a medium (the sample S, the culture solution) with respect to the wavelength.

The offset calculator 22 corresponds to, for example, the CPU 11 of FIG. 2. Using the data stored in the storage 21, the offset calculator 22 calculates a correction amount (an offset amount) used to correct a shift of a focus position of the detection optical system 6 with respect to a plane irradiated with excitation light, the shift of the focus position occurring when the wavelength of excitation light from the light source 1 is switched. In general, the refractive index of a medium with respect to a wavelength of fluorescence is changed when the wavelength of excitation light from the light source 1 is switched, that is, when the wavelength of generated fluorescence is switched from a first wavelength (λ1) to a second wavelength (λ2). This results in shifting the focus position with respect to a plane irradiated with excitation light. The offset calculator 22 calculates the offset amount described above used to correct a shift amount of the focus position in the state after the wavelength is switched from the first wavelength (λ1) to the second wavelength (λ2). A first refractive index (n1) of a medium when fluorescence detected by the detection optical system 6 is at the first wavelength (λ1) and a second refractive index (n2) of the medium when the fluorescence detected by the detection optical system 6 is at the second wavelength (λ2) are used to calculate the offset amount, the medium being situated between the detection optical system 6 and the plane irradiated with excitation light. An example of processing performed by the offset calculator 22 will be described later in detail.

A focus adjustment unit 23 corresponds to, for example, the CPU 11 of FIG. 2. The focus adjustment unit 23 controls the drive motor 8 (a focus adjustment mechanism) using the offset amount calculated by the offset calculator 22, so as to adjust the focus position of the detection optical system 6 to the plane irradiated with excitation light. “To adjust a focus position to a plane irradiated with excitation light using an offset amount” is also referred to as “to offset/to perform an offset”.

A position adjustment unit 24 corresponds to, for example, the CPU 11 of FIG. 2, and controls the drive motor 7 (a position adjustment mechanism) so as to change the relative distance between the detection optical system 6 and the stage 5. The position adjustment unit 24 may control the drive motor 7 according to an input from an input device (not illustrated). The input device is, for example, a keyboard or a mouse. For example, when a user who performs observation using the light sheet illumination microscope 100 wants to change the position to observe the sample S, the user transmits a signal to the position adjustment unit 24 using the input device so as to move the stage 5 via the drive motor 7.

A light source controller 25 corresponds to, for example, the CPU 11 of FIG. 2, and controls a switching of a wavelength of excitation light from the light source 1. Likewise, the light source controller 25 may also perform a control according to an input from the input device (not illustrated).

### First Example

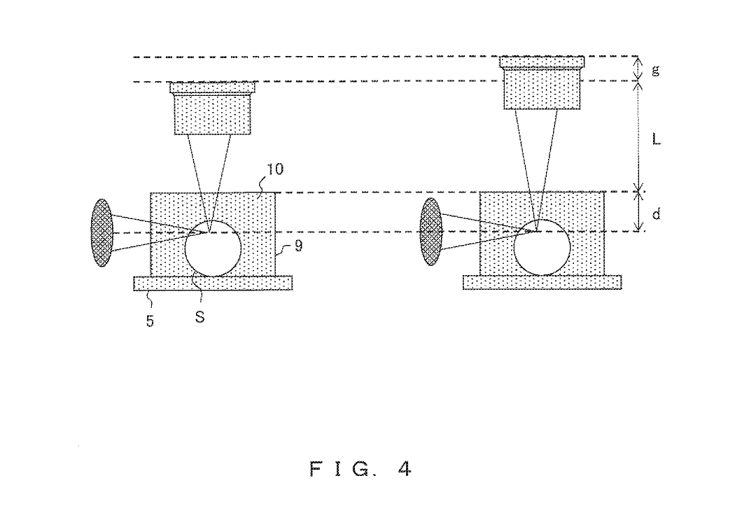

A first example of the processing performed by the offset calculator 22 is described below with reference to the drawings. FIG. 4 illustrates two states in the first example. The two states are a state (on the left side of FIG. 4) in which fluorescence detected by the detection optical system 6 is at a first wavelength (λ1), and a state (on the right side of FIG. 4) in which the focus position has been offset according to an offset amount after the wavelength of the detected fluorescence is switched from the first wavelength to a second wavelength (λ2) according to a switching of a wavelength of excitation light.

In the present embodiment, a distance d in liquid (the culture solution) between an interface of a medium and a plane irradiated with excitation light from the illumination optical system 2 is measured in advance using, for example, a scale. The interface of a medium is an interface between a culture solution and an air. The storage 21 stores therein the distance d in addition to a refractive index of the medium (the sample, the culture solution) for each detected wavelength of fluorescence.

First, it is assumed that, when fluorescence of the first wavelength (λ1) is detected, the focus position of the detection optical system 6 is adjusted to a plane irradiated with sheet light.

When the fluorescence of the first wavelength (λ1) is detected under the condition described above, an air conversion length L1 between a principal plane of the objective 6a of the detection optical system 6 and the plane irradiated with excitation light is obtained using Expression (1) below.

L1=L+d/n1 (1)

Here, d is a distance that generated fluorescence travels in a medium when the wavelength of excitation light is the first wavelength (λ1), L is a length between an interface of the medium and an incident surface of the objective 6a that the fluorescence enters, and n1 is a refractive index of the medium when the detected wavelength is λ1. Further, the refractive index in the air is 1.

Next, in a state in which the wavelength of generated fluorescence and the detected wavelength have been switched from the first wavelength to the second wavelength (λ2), an air conversion length L2 between the principal plane of the objective 6a and the plane irradiated with excitation light is obtained using Expression (2) below.

L2=L+d/n2+g (2)

n2 is a refractive index of the medium with respect to fluorescence when the detected wavelength is λ2, and g is an air conversion length of a portion of a distance that the fluorescence travels in the medium. More specifically, Expression (2) shows, in the state that excitation light of the second wavelength is used, the detection optical system 6 is focused at a position away from the interface by “d/n2+g” obtained by performing a conversion into air. In other words, g corresponds to an air conversion length of a shift amount, the shift amount being a distance between a focus position of the detection optical system when fluorescence is captured in a state in which the wavelength of excitation light is the first wavelength and a focus position of the detection optical system when fluorescence is captured in a state in which the wavelength of excitation light is the second wavelength.

An air conversion length that corresponds to a distance that fluorescence at the first wavelength travels in the medium and an air conversion length that corresponds to a distance that fluorescence at the second wavelength travels in the medium are equal to each other, so g is calculated as below using Formulas (1) and (2).

g=d(1/n1−1/n2) (3)

Thus, according to an offset amount that cancels out the air conversion length of a shift amount obtained using Expression (3), an offset is performed by the focus adjustment unit 23 using the drive motor 8.

FIG. 4 illustrates the case in which the refractive index n2 of a medium after the wavelength is switched is greater than the refractive index n1. In other words, FIG. 4 illustrates an example in which the air conversion length g of a shift amount occurs in a direction in which a distance in the medium is increased, and an offset is performed such that the detection optical system 6 (the objective 6a) moves in a direction in which the detection optical system 6 is away from an irradiated plane.

Accordingly, the offset calculator 22 reads, from the storage 21, the distance d and refractive indexes of a medium that correspond to wavelengths of fluorescence before and after the position change. The offset calculator 22 substitutes the read values into Expression (3) described above so as to obtain an offset amount of a focus position after the wavelength is switched from the first wavelength to the second wavelength. Thus, according to the first example of the present invention, it is possible to correct a shift of the focus position of the detection optical system that occurs when the wavelength of excitation light is switched.

### Second Example

A second example of the processing performed by the offset calculator 22 is described below with reference to the drawings. In the second example, after the position of the sample S is changed by the drive motor 7 (the position adjustment mechanism), that is, after the relative distance between the detection optical system 6 and the stage 5 is changed, the wavelength of excitation light is switched. Then, the offset amount of a focus position when the wavelength of detected fluorescence is switched from a first wavelength to a second wavelength is calculated, so as to perform an offset.

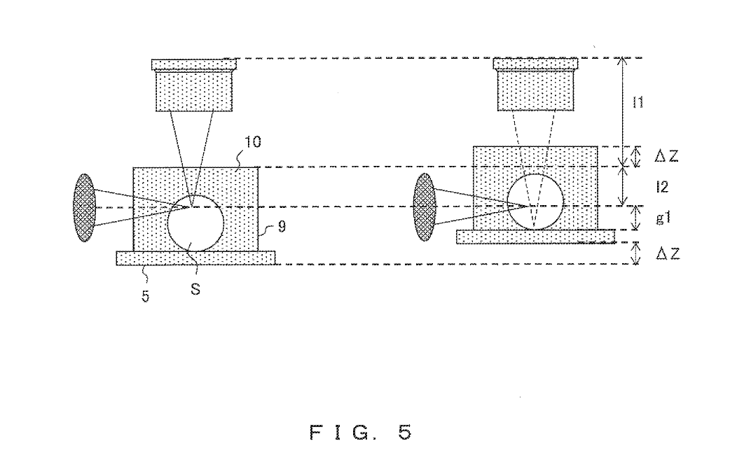

FIG. 5 illustrates two state. One of the two state is a state (on the left side of FIG. 5) before the position is changed by the drive motor 7. The Other state of the two state is a state (on the right side of FIG. 5) after the position is changed by the drive motor 7 (the position adjustment mechanism), that is, a state after the relative distance between the detection optical system 6 and the stage 5 is changed. The thickness of a medium situated between an irradiated plane and the detection optical system 6 is changed due to the position being changed by the drive motor 7. Thus, the focus position when generated fluorescence is captured is shifted after the stage 5 is moved by the drive motor 7. Expression (4) below holds because the air conversion lengths before and after the position is changed by the drive motor 7 are equal to each other. Thus, an air conversion length g1 of a shift amount (a first shift amount) of the focus position when the wavelength of detected fluorescence is the first wavelength is obtained as represented by Expression (5).

l1+l2/n1=l1−ΔZ+(l2+ΔZ)/n1+g1 (4)

g1=ΔZ(1−1/n1) (5)

l1 is a length between an interface of a medium and a principal plane of the objective 6a before the position is changed by the drive motor 7. l2 is a length in liquid between the interface of the medium and a plane irradiated with excitation light before the position is changed by the drive motor 7. AZ is an amount of movement performed by the drive motor 7 (an amount of a change in the relative distance between the detection optical system 6 and the stage 5).

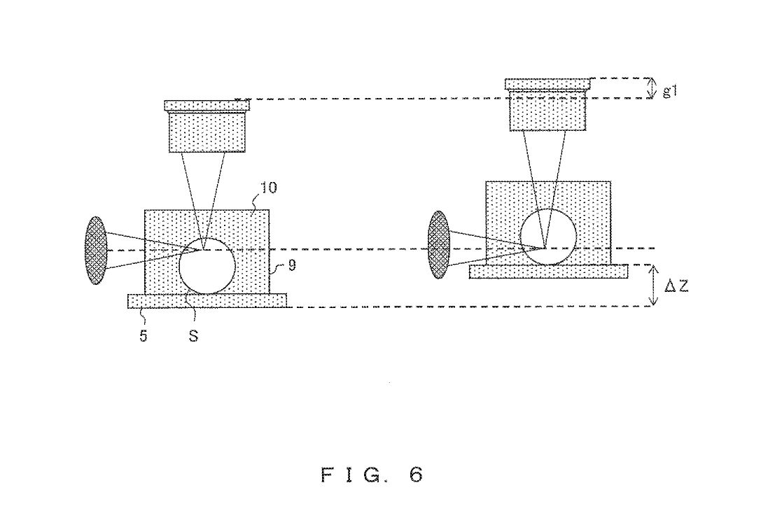

Thus, after the position is changed by the drive motor 7, the focus adjustment unit 23 drives the drive motor 8 such that g1 described above is offset. A state after g1 is offset is indicated on the right side of FIG. 6.

Likewise, when excitation light of the second wavelength is irradiated, an air conversion length g2 of a shift amount (a second shift amount) of the focus position when generated fluorescence is captured in a state in which the stage 5 has been moved by AZ by the drive motor 7 is obtained using Expression (6).

g2=ΔZ(1−1/n2) (6)

Z1 is a position of the detection optical system 6 (the objective 6a) when the focus position of the detection optical system 6 is adjusted to a plane irradiated with excitation light before the position change in a state in which the wavelength of detected fluorescence is the first wavelength, and Z2 is a position of the detection optical system 6 (the objective 6a) when the focus position of the detection optical system 6 is adjusted to the plane irradiated with excitation light before the position change in a state in which the wavelength of detected fluorescence is the second wavelength. Z1 and Z2 are adjusted in advance. For example, a user may find out a position at which an image detected by the detection optical system 6 comes into focus while reviewing the image, so as to perform adjustment. Here, the focus adjustment unit 23 may be controlled according to an input from the user.

In other words, before the position is changed, an air conversion length of an amount of shift between a focus position when the wavelength of fluorescence is the first wavelength and a focus position when the wavelength of fluorescence is the second wavelength is obtained by calculating Z2-Z1.

As described above, after the stage 5 is moved by AZ by the drive motor 7 (g1 has been offset), an air conversion length g of a shift amount of the focus position that occurs when the wavelength of detected fluorescence is switched from the first wavelength to the second wavelength is obtained as below.

g=g2−g1+Z2−Z1=ΔZ(1/n1−1/n2)+Z2−Z1 (7)

Thus, according to an offset amount that cancels out a shift obtained using Expression (7), an offset is performed by the focus adjustment unit 23 using the drive motor 8.

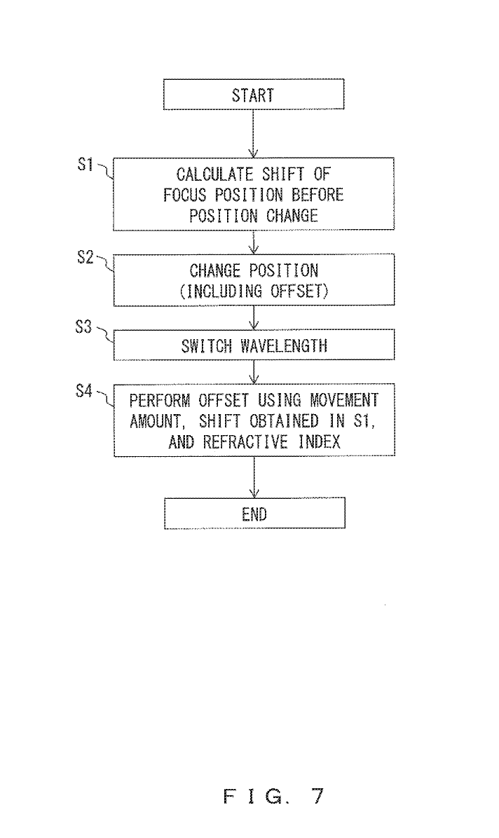

FIG. 7 is a flowchart that illustrates an example of a procedure performed using the light sheet illumination microscope 100 when the offset calculator 22 performs the processing in the second example.

In Step S1, the position Z1 of the detection optical system. 6 (the objective 6a) when the focus position is adjusted in a state in which the wavelength of detected fluorescence is the first wavelength, and the position Z2 of the detection optical system 6 (the objective 6a) when the focus position is adjusted in a state in which the wavelength of detected fluorescence is the second wavelength are recorded before the position change, so as to obtain an air conversion length of a shift amount of the focus position by calculating Z2−Z1. At the time of terminating the process of Step S1, the drive motor 7 performs adjustment so that the stage 5 is situated at the position Z1.

In Step S2, the stage 5 is moved by, for example, ΔZ by the drive motor 7 (the position adjustment mechanism). Here, the offset calculator 22 calculates g1 using Expression (5) described above, and the focus adjustment unit 23 drives the drive motor 8 (the focus adjustment mechanism) such that the above-described air conversion length g1 of a shift amount is offset.

In Step S3, the light source controller 25 switches the wavelength (from the first wavelength to the second wavelength).

In Step S4, the offset calculator 22 calculates an offset amount using the amount ΔZ of a movement of the stage 5 in Step S2, Z2-Z1 calculated in Step S1, and a refractive index read from the storage 21. The focus adjustment unit 23 drives the drive motor 8 (the focus adjustment mechanism) such that the above-described air conversion length g of a shift amount is offset.

According to the second example described above, the offset calculator 22 reads, from the storage 21, refractive indexes of a medium that correspond to wavelengths of excitation light before and after the wavelength switching. Further, the offset calculator 22 substitutes, into Expression (7) described above, an amount (ΔZ) of a movement of the stage that is performed by the drive motor 8, and a shift of the focus position calculated before the position is changed by the drive motor 8. This permits the offset calculator 22 to obtain an offset amount of the focus position after the position of the stage 5 is changed by the drive motor 8 and after the wavelength is switched from the first wavelength to the second wavelength. Further, according to the second example, it is possible to calculate the offset amount without using a distance between an interface and a sheet light plane as in the first example.

The embodiments described above are just examples to facilitate understanding of the present invention, and the embodiment of the present invention is not limited to these examples. Various modifications and alterations may be made to the light sheet illumination microscope described above without departing from the scope of the invention specified in the claims.

What is claimed is:

1. A light sheet illumination microscope comprising:
an illumination optical system that irradiates a medium with sheet-shaped excitation light;
a detection optical system that has an optical axis that intersects an optical axis of the illumination optical system, and detects fluorescence emitted by the medium that is irradiated with the excitation light;
a focus adjustment mechanism that changes a focus position of the detection optical system in a direction of the optical axis of the detection optical system; and
a controller that controls, according to at least a first refractive index and a second refractive index, the focus adjustment mechanism when a wavelength of the fluorescence detected by the detection optical system is switched from a first wavelength to a second wavelength, the first refractive index being a refractive index of the medium with respect to the first wavelength, the second refractive index being a refractive index of the medium with respect to the second wavelength.

2. The light sheet illumination microscope according to claim 1, wherein
when the wavelength of the fluorescence detected by the detection optical system is switched from the first wavelength to the second wavelength, the controller controls the focus adjustment mechanism using at least the first refractive index and the second refractive index, so as to adjust the focus position of the detection optical system to a plane irradiated with the excitation light.

3. The light sheet illumination microscope according to claim 2, wherein
using a distance between the irradiated plane and an interface of the medium, the first refractive index, and the second refractive index, the controller calculates a correction amount depending on a shift between a first focus position and a second focus position, the first focus position being a focus position of the detection optical system in a state in which the wavelength of the fluorescence detected by the detection optical system is the first wavelength, the second focus position being a focus position of the detection optical system in a state in which the wavelength of the fluorescence detected by the detection optical system is the second wavelength, and
when the wavelength of the fluorescence detected by the detection optical system is switched from the first wavelength to the second wavelength, the controller controls the focus adjustment mechanism according to the correction amount, so as to adjust the focus position of the detection optical system to the irradiated plane.

4. The light sheet illumination microscope according to claim 2, further comprising:
a stage on which the medium is fixed; and
a position adjustment mechanism that changes a relative distance between the detection optical system and the stage, wherein
using an amount of a change in the relative distance that is performed by the position adjustment mechanism, the first refractive index, and the second refractive index, the controller calculates a first shift amount and a second shift amount, the first shift amount being an amount of shift of a third focus position with respect to the irradiated plane, the third focus position being a focus position of the detection optical system after the relative distance is changed in a state in which the wavelength of the fluorescence detected by the detection optical system is the first wavelength, the second shift amount being an amount of shift of a fourth focus position with respect to the irradiated plane, the fourth focus position being a focus position of the detection optical system after the relative distance is changed in a state in which the wavelength of the fluorescence detected by the detection optical system is the second wavelength, and
when the wavelength of the fluorescence detected by the detection optical system is switched from the first wavelength to the second wavelength, the controller controls the focus adjustment mechanism according to the first shift amount and the second shift amount, so as to adjust the focus position of the detection optical system to the irradiated plane.

5. The light sheet illumination microscope according to claim 4, wherein
when a focus position of the detection optical system before the relative distance is changed by the position adjustment mechanism in a state in which the wavelength of the fluorescence is the first wavelength is a first focus position, and a focus position of the detection optical system before the relative distance is changed by the position adjustment mechanism in a state in which the wavelength of the fluorescence is the second wavelength is a second focus position,
the controller controls, when the wavelength of the fluorescence detected by the detection optical system is switched from the first wavelength to the second wavelength, the focus adjustment mechanism according to an amount of shift between the first focus position and the second focus position, the first shift amount, and the second shift amount, so as to adjust the focus position of the detection optical system to the irradiated plane.

6. The light sheet illumination microscope according to claim 1, wherein
the focus adjustment mechanism is a drive motor that drives the detection optical system in the direction of the optical axis of the detection optical system.

7. The light sheet illumination microscope according to claim 2, wherein
the focus adjustment mechanism is a drive motor that drives the detection optical system in the direction of the optical axis of the detection optical system.

8. The light sheet illumination microscope according to claim 3, wherein
the focus adjustment mechanism is a drive motor that drives the detection optical system in the direction of the optical axis of the detection optical system.

9. The light sheet illumination microscope according to claim 4, wherein
the focus adjustment mechanism is a drive motor that drives the detection optical system in the direction of the optical axis of the detection optical system.

10. The light sheet illumination microscope according to claim 5, wherein
the focus adjustment mechanism is a drive motor that drives the detection optical system in the direction of the optical axis of the detection optical system.
